(19) United States
(12) Patent Application Publication
(10) Pub. No.: US 2025/0239963 A1
(43) Pub. Date: Jul. 24, 2025

(54) SUPPORT STRUCTURE FOR SOLAR TRACKERS WITH THERMAL EXPANSION MITIGATION

(71) Applicant: Nextracker LLC, Fremont, CA (US)

(72) Inventors: Alexander W. AU, Oakland, CA (US); Jacob Mark Morin, Phoenix, AZ (US); Ryan Patel, Pleasanton, CA (US); Ricardo Delgado-Nanez, San Jose, CA (US); Abhimanyu Anil Sable, Hyderabad, Telangana (IN); Harry Van, Oakland, CA (US)

(21) Appl. No.: 19/033,876

(22) Filed: Jan. 22, 2025

Related U.S. Application Data
(60) Provisional application No. 63/623,740, filed on Jan. 22, 2024.

(51) Int. Cl. H02S 20/32

(52) U.S. Cl. CPC H02S 20/32

(57) ABSTRACT

A support structure for solar trackers with thermal expansion mitigation includes a frame rotatably coupled to one or more ground piles. The support structure further includes a pivot bracket rotatably coupled to a portion of the frame with the pivot bracket including a pivot pin to which torque tube clamps are rotatably coupled. The torque tube clamps are affixed to a torque tube and solar modules are affixed to the torque tube via one or more mounting brackets. Thermal expansion/contraction of the torque tube is translated into rotational movement of the frame relative to the one or more ground piles via the rotatable couplings including the pivot bracket. The rotational movement of the frame relative to the one or more ground piles enables the torque tube to expand/contract while mitigating mechanical stress of the support structure.

### CROSS-REFERENCE TO RELATED APPLICATION

This application claims priority to U.S. Provisional Application Ser. No. 63/623,740, filed Jan. 22, 2024, and entitled “SUPPORT STRUCTURES FOR SOLAR TRACKERS WITH THERMAL EXPANSION MITIGATION,” the disclosure of which is hereby incorporated by reference in its entirety.

### TECHNICAL FIELD

This disclosure generally relates to support structures for solar trackers.

### BACKGROUND

To follow the trajectory of the sun, solar trackers mount solar modules on a torque tube which is rotatably supported on a plurality of piers. During operation of the solar tracker, thermal fluctuations occur daily and seasonably resulting in thermal expansion and contraction of the solar tracker components. In many instances, thermal expansion is not significant enough to impart noticeable forces on the components. However, the torque tubes of the solar trackers can span significant lengths, which results in noticeable expansion and contraction during daily and seasonal temperature fluctuations.

The thermal expansion and contraction of torque tubes can impart substantial axial loads on the support structures. The torque tubes of the solar tracker are rotatably supported on the piers by a coupling. These couplings enable the torque tube to rotate about its longitudinal axis and in many embodiments, enable the torque tube to axially slide within the coupling to accommodate thermal expansion and contraction of the torque tube. Axial movement of the torque tube can impart significant loads on the couplings and the piers supporting them. Axial forces due to expansion and contraction of the torque tube can cause the piers to deflect or otherwise deform to accommodate this axial movement by the torque tube. This deflection by the piers can cause misalignment of the couplings with respect to the torque tubes, which can cause increased friction or binding of the torque tube as the torque tube is rotated within the couplings. This binding or increased friction increases the amount of force required to rotate the torque tube, which in turn, imparts increased load on the actuators or motors effectuating the rotation, and in some instances can cause the torque tube to twist along its length, causing some solar panels to rotate more or less than other solar panels along the length of the torque tube.

### SUMMARY

In general, this disclosure describes a support structure for a solar tracker comprising a pivot bracket rotatably coupled to a frame with the frame rotatably coupled to ground piles. The pivot bracket includes a pivot pin that supports a torque tube via torque tube clamps and optionally mounting brackets. The pivot pin enables the torque tube to rotate about the axis of the pivot pin such that an attached solar tracker can track the sun. The rotatable couplings of the pivot bracket to the frame and the frame to the ground piles enables the entire support structure to adjust to thermal expansion/contraction of the torque tube while keeping the torque tube approximately level. Thermal expansion/contraction of the torque tube is translated into rotational movement of the frame relative to the ground piles but does not add significant mechanical stress to the support structure because of the rotatable couplings.

The details of one or more examples are set forth in the accompanying drawings and the description below. Other features, objects, and advantages will be apparent from the description and drawings, and from the enumerated embodiments.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1 is a side view of a solar tracker according to an aspect of the present disclosure.

FIG. 2 is a perspective view of an example support structure for solar trackers in an exploded configuration according to an aspect of the present disclosure.

FIG. 3A is a perspective view of an example support structure for solar trackers according to an aspect of the present disclosure.

FIG. 3B is a side view of the example support structure for solar trackers of FIG. 3A according to an aspect of the present disclosure.

FIG. 4A is a side view of an example support structure for solar trackers in a first rotated position according to an aspect of the present disclosure.

FIG. 4B is a side view of the example support structure for solar trackers in a second rotated position according to an aspect of the present disclosure.

FIG. 5A is a side view of two example support structures for solar trackers supporting a torque tube having maximum thermal expansion between the two support structures according to an aspect of the present disclosure.

FIG. 5B is a side view of the two example support structures of FIG. 5A supporting a torque tube having maximum thermal contraction between the two support structures according to an aspect of the present disclosure.

FIG. 6A is an alternate embodiment of a support structure for solar trackers according to an aspect of the present disclosure.

FIG. 6B is another alternate embodiment of a support structure for solar trackers according to an aspect of the present disclosure.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

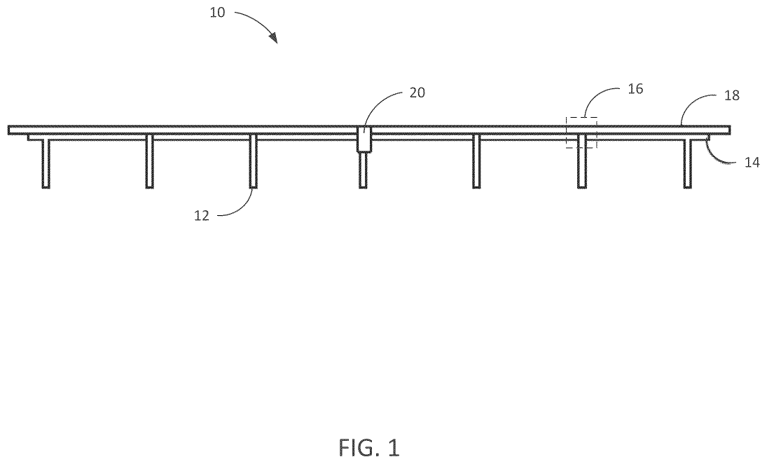

FIG. 1 is a side view of a solar tracker 10 according to an embodiment of the present disclosure. The solar tracker 10 includes a plurality of piers 12 disposed in spaced relation to one another and embedded in the earth. A torque tube 14 extends between the piers 12 and is rotatably supported on each pier 12 by a pivot bracket 16. The solar tracker 10 includes a plurality of solar panels 18 supported on the torque tube 14. In some examples, multiple torque tubes can be used and can span any number of piers. The span between two adjacent piers 12 is referred to as a bay and may be generally in the range of about 8 meters in length. A plurality of solar trackers 10 may be arranged in a north-south longitudinal orientation to form a solar array.

The solar tracker 10 includes at least one slew drive 20 operably coupled to the torque tube 14 and supported on a pier of the plurality of piers 12. The slew drive 20 can drive rotation of the torque tube 14 and the solar panels 18 attached to the torque tube 14 such that the solar panels 18 can track the location of the sun. Other methods for rotating the torque tube 14 can also be used.

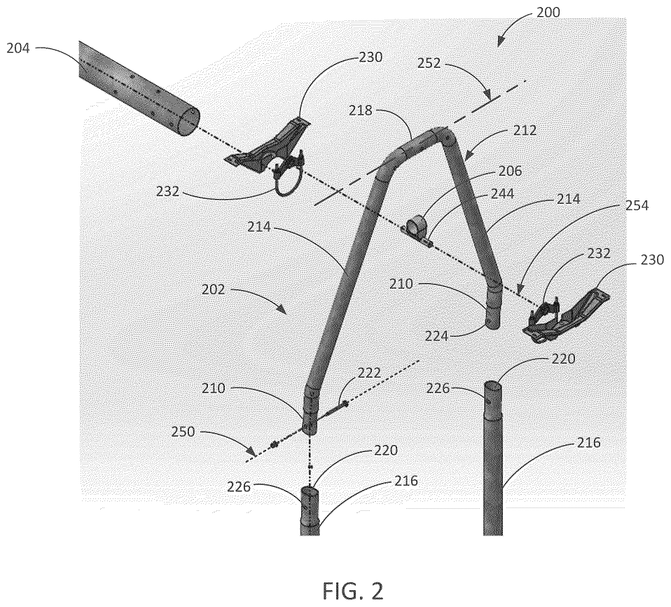

FIG. 2 is a perspective view of an example support structure 200 according to an embodiment of the present disclosure. The support structure 200 includes a pier 202 comprising a frame 212 coupled to ground piles 216. In the illustrated embodiment, the pier 202 comprises a hollow metal tube, though other shapes, materials, and cross-sections can be used. Additionally, in the illustrated embodiment, the frame 212 is an A-Frame formed by two angled legs 214 attached to a top portion 218. Each of the two angled legs 214 of the frame 212 terminate in an end portion 210 that can have a smaller diameter than the angled legs 214. For instance, the end portions 210 can be swagged such that each end portion 210 can be inserted into a corresponding opening 220 defined by the ground piles 216. The openings 220 defined by the ground piles 216 can be large enough to enable the end portions 210 to move within the openings 220 as is further described elsewhere herein.

Each end portion 210 of the frame 212 is coupled to a respective ground pile 216 via a fastener 222 (e.g., bolt, screw, rod). Each fastener 222 passes through holes in the frame 224 and holes in the ground pile 226 which are aligned with one another when the end portions 210 of the frame 212 are inserted into the openings 220 of the ground piles 216. In some examples, a nut, clip, or the like can be used with the fastener to secure the fastener through the holes in the frame 224 and the holes in the ground piles 226.

Because each angled leg 214 of the frame 212 is coupled to a respective ground pile 216 by a single fastener 222, and because each end portion 210 of the frame 212 is sized to be smaller than the respective opening 220 defined by each ground pile 216, the frame 212 can rotate relative to the ground piles 216. In the illustrated example of FIG. 2, the frame 212 can rotate about a horizontal axis 250 defined by the fasteners 222. Accordingly, the top portion 218 of the frame 212 can move laterally relative to the ground.

While the embodiment of FIG. 2 illustrates the end portions 210 of the frame 212 as being smaller than, and being received by, the openings 220 defined by the ground piles 216, in some examples, a reverse of such a connection can be used to secure the frame 212 to the ground piles 216. For instance, in some examples, the end portions of the frame define openings larger than the ground piles such that the ground piles are received by the openings of the end portions of the frame. A fastener can then be inserted through the end portions of the frame and through the ground piles in aligned holes. A nut, clip, or the like can be used with the fastener to secure the fastener through the holes in the frame and the holes in the ground piles. The example of FIG. 2 illustrates one method of rotatably coupling the frame 212 to the ground piles 216, however, other methods are contemplated including, but not limited to, various joints (e.g., hinge joints), bearings, and assemblies.

Continuing with the embodiment of FIG. 2, the support structure 200 further includes a pivot bracket 206. The pivot bracket 206 is configured to be rotatably coupled to the top portion 218 of the frame 212 and is configured to support/effectively couple the torque tube 204 to the frame 212. In FIG. 2, the pivot bracket 206 defines a circular hole into which the top portion 218 of the frame 212 can be inserted and includes a pivot pin 244 to which the torque tube 204 is effectively coupled. In some examples, the top portion 218 of the frame 212 is inserted into the pivot bracket 206, however, in some examples, the pivot bracket 206 is configured to fit around the top portion 218 of the frame 212. For instance, the pivot bracket 206 can include a hinge which enables the circular hole defined by the pivot bracket 206 to open and clasp around the top portion 218 of the frame 212. In some such examples, the pivot bracket can include a fastener, clasp, clamp, or other method of attachment to secure the pivot bracket 206 around the top portion 218 of the frame 212.

In similarity with the circular hole defined by the pivot bracket 206, the top portion 218 of the frame 212 is circular. However, the top portion 218 of the frame has a smaller diameter than the circular opening defined by the pivot bracket 206. The smaller diameter of the top portion 218 relative to the circular hole of the pivot bracket 206 can enable the pivot bracket 206 to rotate about the top portion 218. In FIG. 2, the pivot bracket 206 is rotatable about a horizontal axis 252 defined by the top portion 218 of the frame. The horizontal axis 252 is defined along the center of the circular top portion 218 of the frame. In some examples, the pivot bracket 206 is freely rotatable (e.g., without frictional binding) about the top portion 218. Alternatively, in some examples, the pivot bracket 206 is not freely rotatable about the horizontal axis 252 and requires a certain amount of force to overcome friction between the pivot bracket 206 and the top portion 218 of the frame. In some examples, the pivot bracket 206 may be adjustable between freely rotating about the top portion 218 and being fixed to the top portion 218. For instance, if the pivot bracket 206 includes a hinge to open and clasp around the top portion 218, the fastener, clamp, or other method of attachment to secure the pivot bracket 206 around the top portion 218 can be tightened/loosened to increase/decrease the amount of force necessary to overcome friction between the pivot bracket 206 and the top portion 218 of the frame 212.

The pivot bracket 206 includes the pivot pin 244 which effectively couples the torque tube 204 to the frame 212 to support the torque tube 204. In the example of FIG. 2, the pivot pin 244 extends on either side of the pivot bracket 206 along an axis 254. Each side of the pivot pin 244 is received by an opening defined by a torque tube clamp 232 and rotatably couples the torque tube clamps 232 to the pivot bracket 206. As with the opening defined by the pivot bracket 206, the openings defined by the torque tube clamps 232 are sized to be larger than the pivot pin 244 such that the torque tube clamps 232 can freely (e.g., with minimal friction) rotate about the pivot pin 244.

The torque tube clamps 232 are configured to secure to the torque tube 204 and couple the torque tube 204 to the frame 212 via the rotatable coupling between the torque tube clamps 232 and the pivot pin 244 of the pivot bracket 206. The torque tube clamps 232 can be transitioned between a first, open position, where the torque tube 204 can be inserted into a torque tube clamp 232 and is free to move within the torque tube clamp 232, and a second, closed or clamped position, where the torque tube clamp 232 secures or otherwise inhibits movement of the torque tube 204 within the torque tube clamp 232. The torque tube 204 is effectively supported by the frame 212 and can rotate about the axis 254 defined by the pivot pin 244 when the torque tube clamps 232 are rotatably coupled to the pivot pin 244 of the pivot bracket 206 and are in the closed/clamped position.

Continuing with the example of FIG. 2, the support structure 200 includes support brackets 230. The support brackets 230 are configured to secure to one or more solar modules and to the torque tube 204 to enable the solar modules to rotate with rotation of the torque tube 204 (e.g. to track movement of the sun). The support brackets 230 can be secured to the one or more solar modules via one or more fasteners, though other securing means are contemplated (e.g., clamps, welding, etc.) The support brackets 230 can be directly secured to the torque tube 204 via one or more fasteners (e.g., bolts, screws, and the like). However, in some examples, the support brackets 230 can be secured to the torque tube 204 via the torque tube clamps 232. In some such examples, the torque tube clamps 232 can be in mechanical communication with the support brackets 230. For instance, a top portion of a torque tube clamp 232 can be received within a support bracket 230 such that when a lower portion of the torque tube clamp 232 is transitioned (e.g., tightened) to the closed/clamped position, the torque tube clamp 232 forces the support bracket 230 to frictionally couple to (e.g., fixedly attach to) the torque tube 204. In some examples, a combination of directly fixing the support brackets 230 to the torque tube 204 via fasteners and indirectly fixing the support brackets 230 to the torque tube 204 via torque tube clamps 232 can be used.

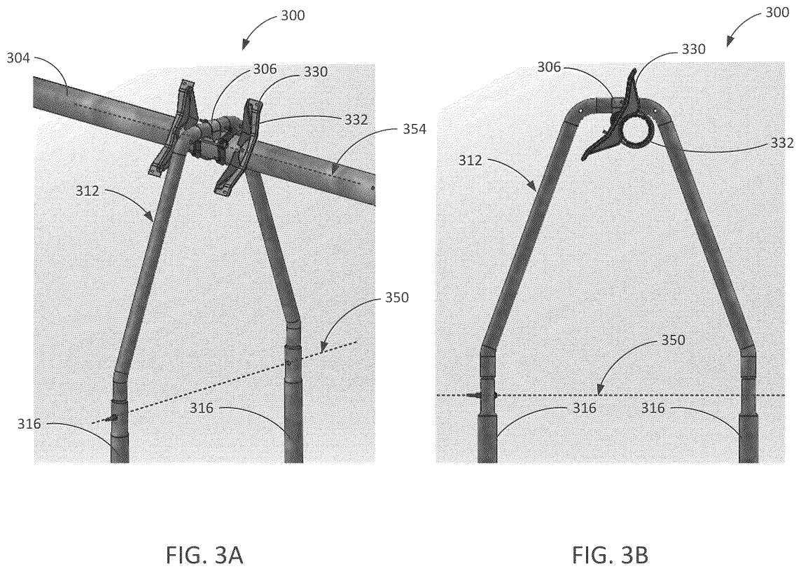

Moving to FIG. 3A and FIG. 3B, FIG. 3A is a perspective view of an example support structure 300 for solar trackers and FIG. 3B is a side view of the example support structure 300 of FIG. 3A according to an aspect of the present disclosure. In FIG. 3A and FIG. 3B, the torque tube 304 is in a rotated position, whereby the torque tube 304 is rotated about an axis 354 defined by the pivot pin (e.g., 244) of the pivot bracket 306. As illustrated, the ground piles 316, which can be driven or otherwise embedded into the ground, are rotatably coupled to and support the frame 312. The frame 312 then supports the pivot bracket 306, which is rotatably coupled to a top portion of the frame 312. The pivot bracket 306 itself supports the torque tube clamps 332, which are rotatably coupled to the pivot bracket 306 via the pivot pins of the pivot bracket 306. Further, the torque tube clamps 332 secure to the torque tube 304 (e.g., are in a closed/clamped position), which enables the torque tube 304 to rotate about the axis 254 defined by the pivot pin of the pivot bracket 306. The support brackets 330 are directly affixed to the torque tube 304 via one or more fasteners. While not pictured, one or more solar modules can be affixed to the support brackets 330. Accordingly, through the various connections of components, one or more solar modules, which are affixed to the torque tube 304, are supported by the ground piles 316. Moreover, as illustrated in FIG. 3A and FIG. 3B, the connections of components enable the torque tube 304, and any attached solar modules, to rotate about the axis 354 to enable the solar modules to track the sun.

As illustrated in FIG. 3B, the torque tube 304 is at a maximum rotation, or near maximum rotation, in one direction. In some examples, the torque tube 304 is limited in its rotation by the frame 312 as the torque tube 304 will contact a top portion of the frame 312 and be unable to rotate further. In some examples, to enable a greater rotation, the pivot pin of the pivot bracket 306, which supports the torque tube 304 via the torque tube clamps 332, may extend further downward (e.g., toward the ground), such that the axis of rotation 354 is also extended further downward.

As discussed elsewhere herein, the support structure 300 can include an axis 350 about which the frame 312 can rotate relative to the ground piles 316. The example of FIGS. 3A and 3B illustrates the frame 312 in line with (e.g., not rotated relative to) the ground piles 316.

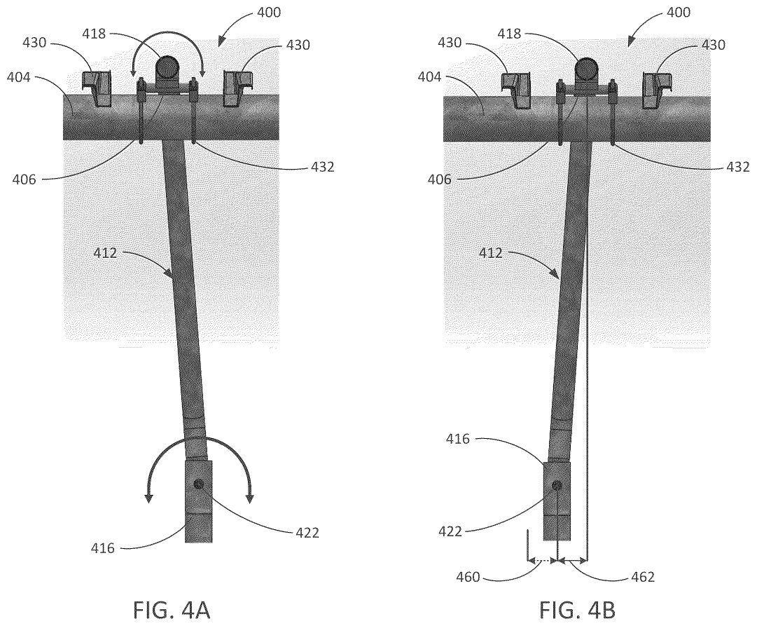

Moving to FIG. 4A and FIG. 4B, FIG. 4A is a side view of an example support structure 400 for solar trackers in a first rotated position while FIG. 4B is a side view of the example support structure 400 in a second rotated position. In the first rotated position, the frame 412 is maximally rotated counterclockwise relative to the ground pile 416 about the axis defined along the fastener 422 (e.g., axis 350 of FIG. 3A/B). Thus, instead of being in-line with (e.g., directly above) the ground pile 416 the frame 412 extends leftward of the ground pile 416 in the first rotated position. In the second rotated position, the frame 412 is maximally rotated clockwise relative to the ground pile 416 about the axis defined along the fastener 422. Thus, instead of being in-line with the ground pile 416, the frame 412 extends rightward of the ground pile 416 in the second rotated position.

As described elsewhere herein, the frame 412 is rotatably coupled to the ground pile 416 (e.g., via a fastener 422, pin, or the like) and can rotate relative to the ground pile 416 as illustrated by the double-sided arrow centered about the axis of rotation. The frame 412 can rotate relative to the ground pile 416 partly because of the use of a single fastener 422, which defines an axis about which the frame 412 can rotate (e.g., 350 of FIG. 3A/B), and because the frame 412 has end portions that are sized smaller than an opening of the ground pile 416 which receives the end portions of the frame. In other terms, the frame 412 has some play (e.g., space) with the ground pile 416 that enables the relative rotation between the frame 412 and the ground pile 416.

Because the pivot bracket 406 is rotatably coupled to the frame 412, when the frame 412 rotates relative to the ground pile 416, as in the first or second rotated positions, the pivot bracket 406 also rotates, as indicated by the double-sided arrow centered about the axis of rotation. As described elsewhere herein, the pivot bracket 406 rotates about an axis (e.g., 252 of FIG. 2) defined by the top portion 418 of the frame 412 and thus rotates relative to the frame 412. Further, because the pivot bracket 406 is coupled to the torque tube 404 via the torque tube clamps 432, and because the pivot bracket 406 rotates when the frame 412 rotates relative to the ground pile 416, rotation of the frame 412 relative to the ground pile 416 does not translate to the torque tube 404. Instead, the rotation of the pivot bracket 406 maintains the torque tube 404 in an approximately level position. In some examples, with the rotation of both the frame 412 relative to the ground pile 416 and the rotation of the pivot bracket 406 relative to the frame 412, solar modules attached to the torque tube via the support brackets 430 may move laterally relative to the ground, and a height of the torque tube 404 relative to the ground may slightly decrease while remaining approximately level.

The rotational movement of the frame 412 relative to the ground pile 416 enables the torque tube 404 to significantly expand and/or contract lengthwise (e.g., due to thermal expansion) without adding significant stress to the overall support structure. Lengthwise thermal expansion/contraction of the torque tube 404 is transferred into rotational movement of the frame 412 relative to the ground pile 416 through the various couplings, including the rotation of the pivot bracket 406. For example, in FIG. 4A, thermal expansion/contraction of the torque tube 404 can cause the torque tube 404 to impart a lateral force to the pivot bracket 406. Because the pivot bracket 406 is rotatably coupled to the top portion 418 of the frame 412, the lateral force causes the pivot bracket 406 to rotate relative to the top portion 418 and transfer the lateral force to the top portion 418 of the frame 412. Further, because the frame 412 is rotatably coupled to the ground pile 416, the lateral force at the top portion 418 of the frame 412 causes the frame 412 to rotate counterclockwise relative to the ground pile 416.

Compared to other support structures, the transfer of lengthwise thermal expansion into rotational movement of the frame 412 relative to the ground pile 416 can enable significant thermal expansion/contraction of the torque tube 404 without adding stress to the support structure 400. For instance, the amount of thermal expansion of the torque tube 404 that the illustrated support structure of FIG. 4A/B can compensate for includes the added distances 460 and 462. The distance 462 is defined as the horizontal distance between the center of the top portion 418 of the frame 412 in the second rotational position (e.g., maximum rotation of the frame 412 relative to the ground pile 416 in the clockwise direction) relative to a center of the ground pile 416, which extends along the ground pile. Similarly, the distance 460 is defined as the horizontal distance between the center of the top portion 418 of the frame 412 in the first rotational position (e.g., maximum rotation of the frame 412 relative to the ground pile 416 in the counterclockwise direction) relative to a center of the ground pile 416, which extends along the ground pile 416.

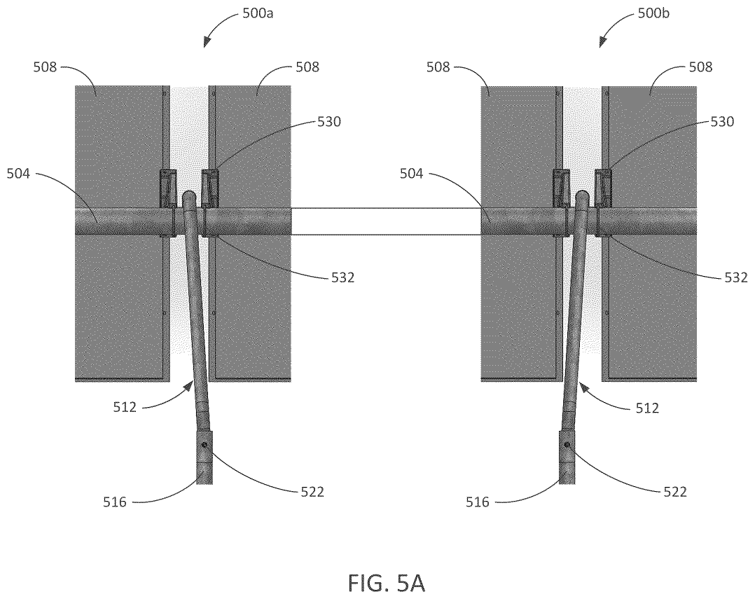

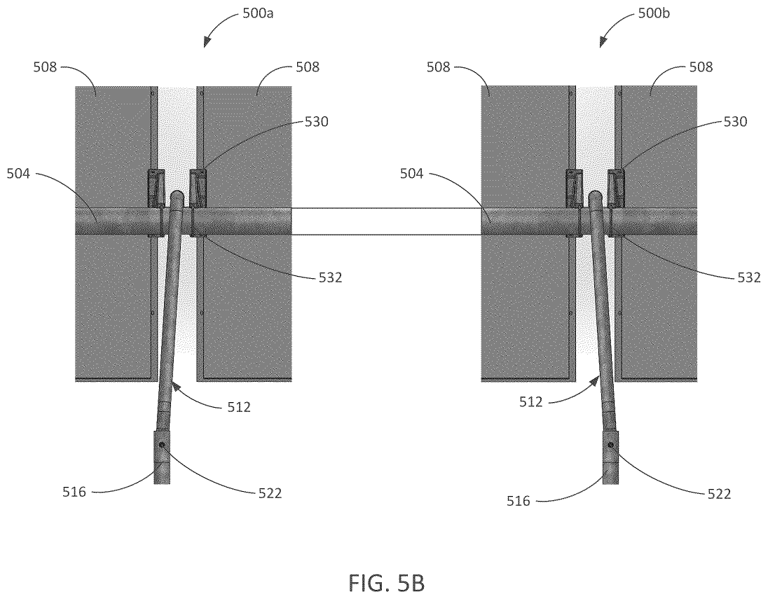

FIG. 5A is a side view of two example support structures 500a, 500b for solar trackers supporting a torque tube 504 having maximum thermal expansion between the two support structures 500a, 500b while FIG. 5B is a side view of the two example support structures 500a, 500b of FIG. 5A supporting a torque tube 504 having maximum thermal contraction between the two support structures. Additionally, the examples of FIG. 5A and FIG. 5B illustrate the solar modules 508 being secured to the torque tube 504 via indirect means as is described elsewhere herein. Specifically, the torque tube clamps 532 are received within the support brackets 530, with the solar modules 508 being directly secured to the support brackets via fasteners.

Referring to FIGS. 4A/4B and FIGS. 5A/5B, adding the distances 560 and 562 yields a maximum thermal expansion/contraction distance between two piers. In some examples, the distances 560 and 562 are each about 3.6 inches, or approximately 7.2 inches when added together. In FIG. 5A, the extent of the torque tube 504 that is between the ground piles 116 is expanded a maximum amount (e.g., 7.2 inches) as for each ground pile 516, the frame 512 is rotated maximally outward from the center of each ground pile 116. In FIG. 5B, the extent of the torque tube 504 that is between the ground piles 516 is contracted a maximum amount (e.g., 7.2 inches) as for each ground pile 516, the frame 512 is rotated maximally inward from the center of each ground pile 516.

While the torque tube 504 is illustrated as extending between only two piers in FIGS. 5A and 5B, the torque tube 504 can extend between any number of piers. In such embodiments, because the torque tube is generally rigid, if the frame of a first pier is rotated relative to the ground pile of the first pier, the frame of a second pier will also be rotated some amount relative to the ground pile of the second pier. For instance, in some examples, the maximum thermal expansion/contraction of a torque tube that extends between any number of piers is the same maximum thermal expansion/contraction of the torque tube that extends between only two piers. This is because the expansion/contraction is transferred between piers connected by the same torque tube via the rotation of the frames relative to the ground piles, with the exception of the piers at the end of the torque tube. The piers at the end of the torque tube will each be able to compensate for the expansion/contraction of the torque tube the same amount as in the illustrated embodiments of FIG. 5A (for expansion) and FIG. 5B (for contraction) due to the rotation of their respective frames to their respective ground piles.

As one having ordinary skill in the art will appreciate, the amount of thermal expansion/contraction the support structure can compensate for using the rotation of frames relative to their ground piles can be varied. For example, changing the play between a frame and its corresponding ground pile can change the amount the frame can rotate relative to the ground pile. Further, changing a height of the frame can also change the distance the top portion of the frame can move laterally relative to the ground pile.

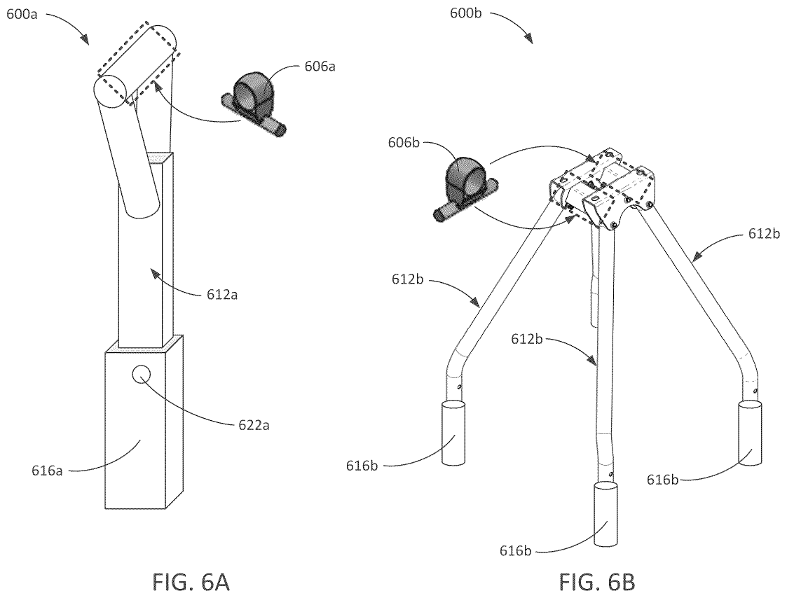

Moving to FIG. 6A and FIG. 6B, FIG. 6A and FIG. 6B are alternative embodiments of a support structure 600a, 600b for solar trackers. In FIG. 6A, instead of a frame that is A-shaped and uses multiple ground piles (e.g., as in the embodiment of FIG. 3A/3B), the support structure 600a has a frame 612a with a Y-shaped top portion, a square frame, and a single, square ground pile 616a. However, in similarity with other examples disclosed herein, the support structure 600a includes the pivot bracket 606a, which can be rotatably coupled to the top portion of the frame 612a. Further, the frame 612a is rotatably coupled to the ground pile 616a via a fastener 622a, about which the frame 612a can rotate. Thus, the support structure 600a can mitigate thermal expansion/contraction in a similar manner as is described elsewhere herein.

In FIG. 6B, the support structure 600b has a frame 612b comprising four individual pieces joined together by a top portion of the frame 612b. Each frame piece has a corresponding ground pile 616b to which it is rotatably coupled. Further, the support structure 600b includes the pivot bracket 606b, which can be rotatably coupled to one of the top portions of the frame 612b. Thus, the support structure 600b can mitigate thermal expansion/contraction in a similar manner as is described elsewhere herein.

A person having ordinary skill in the art will appreciate that the embodiments of FIG. 6A and FIG. 6B are merely examples illustrating that any number and shape of piers, frames, and ground piles can be used, and that this disclosure is not limited to the illustrated embodiments.

Various examples have been described. These and other examples are within the scope of the following claims.

It will be appreciated that directional language, e.g., north, south, east, west, referenced herein, is referring generally to such directions and not necessarily to the precise direction. For example, north-south, east-west directions may mean true north-south, true east-west, or approximately north, approximately south, approximately east, or approximately west, for example, within a ±44° range of true north-south, east-west.

What is claimed is:

1. A solar tracker support structure comprising:
a torque tube configured to span a length of a row of the solar tracker, the torque tube defining a torque tube axis extending centrally therethrough;
a first ground pile;
a first leg, the first leg comprising a first leg proximal end portion and a first leg distal end portion, the first leg distal portion rotatably coupled to the first ground pile;
a torque tube clamp coupled to the proximal end portion of the first leg, the torque tube clamp configured to support the torque tube;
wherein the first leg distal portion is rotatably coupled to the first ground pile about an axis transverse to the torque tube axis and wherein the torque tube clamp is rotatably coupled to the proximal end portion of the first leg about an axis transverse to the torque tube axis such that axial movement of the torque tube corresponds with rotational movement of the first leg with respect to the first ground pile.

2. The solar tracker support structure of claim 1, wherein the torque tube clamp is rotatably coupled to the proximal end of the first leg about an axis transverse to the torque tube axis.

3. The solar tracker support structure of claim 1, wherein the torque tube axis is in a north-south direction, and the axis transverse to the torque tube axis is substantially in an east-west direction.

4. The solar tracker support structure of claim 1, wherein the torque tube clamp is further rotatably coupled to the proximal end portion of the first leg about an axis parallel to and at a distance from the torque tube axis.

5. The solar tracker support structure of claim 1, further comprising:
a second leg, the second leg comprising a second leg proximal end portion and a second leg distal end portion;
a bridge extending between the first leg proximal end portion and the second leg proximal end portion.

6. The solar tracker support structure of claim 5, wherein the torque tube clamp is disposed on the bridge.

7. The solar tracker support structure of claim 6, wherein the second leg distal end portion is configured to couple to a second ground pile.

8. The solar tracker support structure of claim 7, further comprising:
a third leg coupled to a third ground pile, the third leg comprising a third leg proximal end portion and a third leg distal end portion; and
a fourth leg coupled to a fourth ground pile, the fourth leg comprising a fourth leg proximal end portion and a fourth leg distal end portion;
wherein the bridge extends between the first leg proximal end portion, the second leg proximal portion, the third leg proximal portion, and the fourth leg proximal portion.

9. The solar tracker support structure of claim 5, wherein the torque tube clamp is further rotatably coupled to the proximal end portion of the first leg about an axis parallel to and at a distance from the torque tube axis.

10. The solar tracker support structure of claim 1, wherein the first leg distal portion is rotatably coupled to the first ground pile via a pin joint.

11. A solar tracker support structure comprising:
a. a torque tube configured to span a length of a row of the solar tracker, the torque tube defining a torque tube axis;
b. a ground support comprising:
i. a first ground pile;
ii. a first leg comprising a proximal end and a distal end, and
iii. a pin joint rotatably coupling the distal end and the first ground pile about an axis transverse to the torque tube axis;
c. a torque tube support comprising:
i. a pivot bracket coupled to the proximal end of the first leg;
ii. a torque tube clamp coupled to the pivot bracket, the torque tube clamp configured to support the torque tube;
wherein axial movement of the torque tube corresponds with rotational movement of the first leg with respect to the first ground pile.

12. The solar tracker support structure of claim 11, wherein the pivot bracket is rotatably coupled to the proximal end of the first leg about an axis transverse to the torque tube axis.

13. The solar tracker support structure of claim 11, wherein the pivot bracket comprises a Y-shaped top portion that is coupled to the proximal end of the first leg via a pin joint.

14. The solar tracker support structure of claim 11, wherein the torque tube clamp is further rotatably coupled to the proximal end of the first leg about an axis parallel to and at a distance from the torque tube axis.

15. The solar tracker support structure of claim 11, wherein the ground support further comprises:
i. a second ground pile;
ii. a second leg comprising a proximal end and a distal end, and
iii. a pin joint rotatably coupling the distal end of the second leg and the second ground pile about an axis transverse to the torque tube axis.

16. The solar tracker support structure of claim 15, wherein the pivot bracket extends between the proximal end of the first leg and the proximal end of the second leg.

17. The solar tracker support structure of claim 15, wherein the torque tube clamp is further rotatably coupled to the proximal end of the first leg about an axis parallel to and at a distance from the torque tube axis.

18. The solar tracker support structure of claim 15, further comprising:
i. a third ground pile;
ii. a third leg comprising a proximal end and a distal end, and
iii. a pin joint rotatably coupling the distal end of the third leg and the third ground pile about an axis transverse to the torque tube axis;
iv. a fourth ground pile;
v. a fourth leg comprising a proximal end and a distal end, and
vi. a pin joint rotatably coupling the distal end of the fourth leg and the fourth ground pile about an axis transverse to the torque tube axis.

19. The solar tracker support structure of claim 18, wherein the pivot bracket extends between the proximal end of the first leg, the proximal end of the second leg, the proximal end of the third leg, and the proximal end of the fourth leg.

20. The solar tracker support structure of claim 18, wherein the torque tube clamp is further rotatably coupled to the proximal end of the first leg about an axis parallel to and at a distance from the torque tube axis.

21. A solar tracker support structure comprising:
a torque tube having a length and defining a torque tube axis;
a ground pile;
a leg comprising a proximal end and a distal end, the distal end rotatably coupled to the ground pile;
a torque tube clamp coupled to the proximal end, the torque tube clamp configured to support the torque tube;
wherein the distal end is rotatably coupled to the ground pile about an axis transverse to the torque tube axis and wherein the torque tube clamp is coupled to the proximal end of the leg such that axial movement of the torque tube corresponds with rotational movement of the leg with respect to the ground pile.

22. The solar tracker support structure of claim 21, wherein the leg is a first leg, and further comprising:
a second leg comprising a proximal end and a distal end; and
a bridge extending between the proximal end of the first leg and the proximal end of the second leg;
wherein the torque tube clamp is rotatably coupled to the bridge about an axis parallel to and at a distance from the torque tube axis.

23. The solar tracker support structure of claim 21, wherein the torque tube clamp is rotatably coupled to the proximal end of the leg about an axis transverse to the torque tube axis.
